(19) United States
(12) Patent Application Publication
(10) Pub. No.: US 2015/0101985 A1
(43) Pub. Date: Apr. 16, 2015

(54) Method for Separating Water/Ethanol Using NAA Zeolite Separator

(71) Applicant: Korea Institute of Energy Research, Daejeon (KR)

(72) Inventors: Jeong-Gu Yeo, Daejeon (KR); Churl-Hee Cho, Daejeon (KR)

(21) Appl. No.: 14/386,034

(22) PCT Filed: Mar. 20, 2013
(86) PCT No.: PCT/KR2013/002268

§ 371 Date: Dec. 31, 2014

(30) Foreign Application Priority Data
Mar. 21, 2012 (KR) 10-2012-0028704

(51) Int. Cl. B01D 61/36; B01D 71/02

(52) U.S. Cl. CPC B01D 61/362; B01D 71/028
USPC 210/640

(57) ABSTRACT

Disclosed herein are a method of preparing a NaA zeolite membrane for water/ethanol separation, and a method of separating water/ethanol using the same, wherein a water/ethanol mixture is separated by pervaporation using a NaA zeolite membrane employing a dual separation process, including: primary separation for increasing an ethanol concentration to 95˜97 wt % using a membrane having high water selectivity and low flux; and secondary separation for increasing the ethanol concentration to 97˜100 wt % using a membrane having low water selectivity and high flux, thereby obtaining excellent separation efficiency at comparatively low energy.

### TECHNICAL FIELD

The present invention relates to a water/ethanol separation method. More particularly, the present invention relates to a method of separating water from a water/ethanol mixture, wherein primary extraction for separating water so that ethanol content is 97 wt % and secondary extraction for separating water so that ethanol content is 100 wt % are performed, thereby easily extracting water from the water/ethanol mixture.

### BACKGROUND ART

A variety of membranes are generally utilized for water/ethanol separation, and especially hydrophilic membranes are useful for dehydration for ethanol purification.

Such a membrane is typically exemplified by a polyvinylethanol membrane available from GFT, Germany, which has been developed using maleic anhydride as a crosslinking agent of polyvinylethanol. However, this membrane has trouble not to achieve proper values of permeability and selectivity.

To solve the problems with the polyvinylethanol membrane, attempts have been made to crosslink polyvinylethanol using various crosslinking agents. For example, the use of a monomer such as glutaraldehyde or a polymer such as poly(acrylic acid) as the crosslinking agent is disclosed. However, the monomer such as glutaraldehyde serving as the crosslinking agent has no extra functional group to enhance hydrophilicity of the membrane to be crosslinked. Hydrophilicity of the membrane after crosslinking may be deteriorated. In particular, membranes thus obtained typically exhibit selectivity lower than the expected level, due to lowered hydrophilicity.

In addition to the polyvinylethanol, the use of a polysaccharide-based hydrophilic polymer such as chitosan or sodium alginate is disclosed. A membrane using a chitosan or sodium alginate polymer has very high strength and a bulky structure, so that a high free volume is formed in the membrane. Such a high free volume facilitates diffusion of water molecules, thus manifesting relatively high permeability.

Since these polymers have hydrophilic hydroxyl group (—OH) and ionic groups on the backbone thereof, they are highly hydrophilic, and thereby the resulting polymer membrane may manifest high water selectivity from the water/ethanol mixture. Hence, this membrane using the hydrophilic polymer is regarded as very suitable for separation of a water/ethanol mixture.

However, since the membrane made of the hydrophilic polymer has too high hydrophilicity, its stability may deteriorate in a water/ethanol mixture having high water content. Specifically, the membrane having high water solubility may absorb an excessively large amount of water from the water/ethanol mixture having high water content, undesirably deteriorating stability of the membrane and exhibiting poor water/ethanol separation performance of the membrane.

### DISCLOSURE

### Technical Problem

Accordingly, the present invention employs pervaporation using a membrane to separate water from a water/ethanol mixture. As such, a dual separation process is carried out, which includes primary separation using a zeolite membrane having high water selectivity and low flux and secondary separation using a zeolite membrane having low water selectivity and high flux.

Therefore, the present invention is intended to provide a method of separating water/ethanol, which may facilitate the water/ethanol separation.

### Technical Solution

An embodiment of the present invention provides a method of separating water/ethanol, comprising: (a) separating a water/ethanol mixture so that an ethanol concentration is increased to 95˜97 wt % using a membrane having a first water selectivity and a first flux; and (b) separating water and ethanol of a product obtained in (a) so that the ethanol concentration is increased to 97˜100 wt % using a membrane having a second water selectivity lower than the first water selectivity and a second flux higher than the first flux.

Another embodiment of the present invention provides a method of separating water/ethanol, comprising: (a′) separating a water/ethanol mixture so that an ethanol concentration is increased to 95˜97 wt % via pervaporation using a first NaA zeolite membrane having a first water selectivity and a first flux; and (b′) separating the water/ethanol mixture having the ethanol concentration of 95˜97% so that the ethanol concentration is increased to 97˜100 wt % via pervaporation using a second NaA zeolite membrane having a second water selectivity lower than the first water selectivity and a second flux higher than the first flux.

As such, the first NaA zeolite membrane may be prepared by hydrothermal synthesis for a period of time ranging from 1 hr to less than 12 hr, and the second NaA zeolite membrane may be prepared by hydrothermal synthesis for 12˜24 hr.

Preferably, the first water selectivity is 3,500˜5,000, and the first flux is 50˜1,000 g/m²hr; and the second water selectivity is 1,000˜3,500, and the second flux is 1,000˜2,000 g/m²hr.

### Advantageous Effects

According to the present invention, a method of separating water/ethanol can be performed using a dual separation process including primary separation using a zeolite membrane having high water selectivity and low flux and secondary separation using a zeolite membrane having low water selectivity and high flux, thus facilitating the water/ethanol separation.

Also, according to the present invention, a NaA zeolite membrane for water/ethanol separation employs nano-sized seed crystals, thus uniformly forming a NaA zeolite layer and decreasing defects, thereby maximizing water/ethanol separation performance.

Furthermore, the NaA zeolite membrane for water/ethanol separation does not deteriorate in durability despite the continuous separation process, thus reducing the operation and maintenance cost for the separation system and easily performing the water/ethanol separation process.

### DESCRIPTION OF DRAWINGS

FIG. 1 is a plot of the permeation time versus the ethanol concentration in the course of water/ethanol separation according to an embodiment of the present invention; and

FIG. 2 is a graph illustrating a flux of the region in which the ethanol concentration is 95 wt % or more in the graph of FIG. 1.

### MODE FOR INVENTION

Hereinafter, a detailed description will be given of a method of separating water/ethanol according to the present invention with reference to the accompanying drawings.

According to the present invention, the method of separating water/ethanol includes primarily separating a water/ethanol mixture so that an ethanol concentration is increased to 95˜97 wt % using a membrane having high water selectivity and low flux and secondarily separating the product obtained from primary separation so that the ethanol concentration is increased to 97˜100 wt % using a zeolite membrane having low water selectivity and high flux.

To typically separate water/ethanol, enhancement in separation performance may be taken into consideration by increasing flux and then selectivity. In lieu of such consideration, however, attempts have been made by the present inventors to increase selectivity and then flux, ultimately obtaining very efficient water/ethanol separation results.

When the primary separation at high selectivity and the secondary separation at high flux are performed in this way, excellent separation efficiency may result even at low cost.

Such a separation process is preferably exemplified by pervaporation using a NaA zeolite membrane, which is specified as follows.

The NaA zeolite membranes may be prepared by a hydrothermal synthesis process using a seed crystal solution, as in typical NaA zeolite membrane preparation methods. For example, the NaA zeolite membrane may be prepared by growing a NaA zeolite layer on the surface of a support having NaA zeolite seed crystals attached thereto via hydrothermal synthesis using an Al₂O₃-2SiO₂-4.5Na₂O-600H₂O seed crystal solution. In addition thereto, any process may be utilized without limitation so long as it is known as NaA zeolite membrane preparation methods using hydrothermal synthesis.

In the present invention, changes in selectivity and flux of the zeolite membrane may be achieved by controlling hydrothermal synthesis process conditions. Specifically, the selectivity may be increased by conducting hydrothermal synthesis for a period of time ranging from 1 hr to less than 12 hr, and the flux may be increased by performing hydrothermal synthesis for 12˜24 hr. During the hydrothermal synthesis, zeolite crystals are grown from the seed crystals to uniformly form a zeolite membrane, which is then converted into a dense and uniform membrane structure over time. Consequently, a zeolite membrane having high selectivity depending on the time variable may be obtained.

A period of time required to form a uniform membrane structure is preferably set to the range from ones of hr to 12 hr. When this synthesis time is more than 12 hr, zeolite crystallinity may increase. Furthermore, the particle size may become uniform and the size distribution is stable and may thus become narrow. In this procedure, zeolite crystallinity may reach 100%, so that inner pores of zeolite may be developed into a certain size. Zeolite having well-developed pores with a certain size may function to increase permeability of separation material.

Consequently, the flux, corresponding to the permeate flowrate of material per unit area, may increase. This period of time empirically falls in the range of half a day to a day. The flux of the zeolite membrane is based on the intracrystalline void and the pores between the crystals. As the hydrothermal synthesis further proceeds, the size and shape of the pores between the crystals may become uniform.

In the primary water/ethanol separation, a first NaA zeolite membrane may have a water selectivity of 3,500˜5,000, and a flux of 50˜1,000 g/m²hr, so that the ethanol concentration may be increased to 95˜97 wt %.

At those times, the water selectivity need not be sequentially increased, and any value in the above range may be selectively used. Also, the flux need not be sequentially decreased from the maximum range to the minimum range. Thus, the present invention is not limited by the terms “high” or “low”, which are identically applied to the following description.

If the water selectivity is less than 3,500, the ethanol concentration cannot be increased to 95 wt % or more. In contrast, if the water selectivity exceeds 5,000, the ethanol concentration may be increased but the flux is drastically reduced to less than 50 g/m²hr, remarkably deteriorating the water/ethanol separation efficiency. Moreover, if the flux exceeds 1,000 g/m²hr, the water selectivity may decrease, and thus the ethanol concentration may be lowered.

Next, in the secondary water/ethanol separation, a second NaA zeolite membrane may have a water selectivity of 1,000˜3,500, and a flux of 1,000˜2,000 g/m²hr, and thereby the ethanol concentration may be increased to 97˜100 wt %. As such, if the water selectivity is less than 1,000, the ethanol concentration cannot be increased to 97 wt % or more. In contrast, if the water selectivity exceeds 5,000, the ethanol concentration may be increased but the flux is lowered to less than 1,000 g/m²hr, remarkably deteriorating the water/ethanol separation efficiency. Moreover, if the flux exceeds 2,000 g/m²hr, the water selectivity may decrease, and thus the ethanol concentration may be reduced.

As mentioned above, the method of separating water/ethanol according to the present invention can exhibit superior separation efficiency and economic benefits, compared to existing separation methods.

Furthermore, the NaA zeolite membrane has good durability, thus increasing the lifetime of the water/ethanol pervaporation device and thus reducing the operation and maintenance cost.

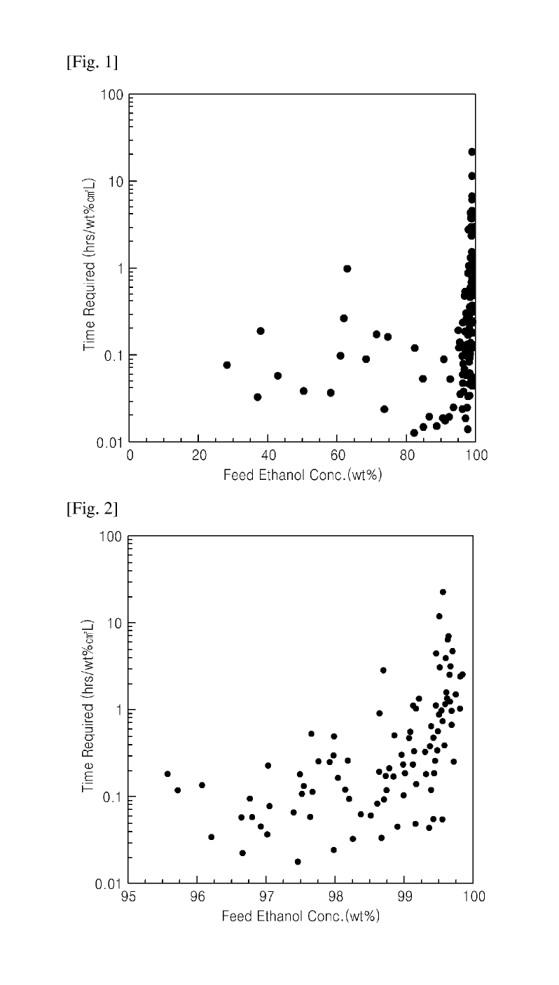

FIG. 2 is a plot illustrating the flux of the region in which the ethanol concentration is 95 wt % or more in the graph of FIG. 1.

As illustrated in FIG. 2, the extent of increasing the flux is high from the point of time at which the ethanol concentration is 97 wt % or more in the region in which the ethanol concentration is 95 wt % or more in the graph of FIG. 1.

The Y axis of FIG. 1 shows a period of time required to increase the concentration of a 1 L solution fed into a 1 cm² membrane by 1% more than the concentration of the X axis. As the concentration of ethanol feed is higher, the period of time required for 1% concentration may increase.

When membranes having high selectivity and high flux are conversely disposed, namely, when a high flux membrane is disposed upstream and then a high selectivity membrane is disposed downstream, a drastically long separation time is required and thus commercial use thereof is limited. When zeolite having high selectivity is disposed downstream, ethanol having very high concentration treated upstream has to be separated at high concentration, and as shown in FIG. 2, the separation time may be considerably long, making it impossible to perform actual water/ethanol separation. Hence, this case cannot be commercially employed.

As mentioned above, the water/ethanol separation method according to the present invention may be carried out by a dual separation process including primary separation using a membrane having high water selectivity and low flux and secondary separation using a membrane having low water selectivity and high flux, thus facilitating the water/ethanol separation.

Moreover, the NaA zeolite membrane for use in the water/ethanol separation according to the present invention employs nano-sized seed crystals, so that the NaA zeolite layer may be uniformly formed, and defects may decrease, thus maintaining durability and thereby reducing the maintenance cost for the separation system and easily carrying out the water/ethanol separation process.

Although the preferred embodiments of the present invention have been disclosed for illustrative purposes, the person skilled in the art will appreciate that various modifications, additions and substitutions are possible, without departing from the scope and spirit of the invention as disclosed in the accompanying claims. Therefore, the scope of the present invention has to be determined by the following claims.

1. A method of separating water/ethanol, comprising:
(a) separating a water/ethanol mixture so that an ethanol concentration is increased to 95˜97 wt % using a first membrane having a first water selectivity and a first flux; and
(b) separating water and ethanol of a product obtained in (a) so that the ethanol concentration is increased to 97˜100 wt % using a second membrane having a second water selectivity lower than the first water selectivity and a second flux higher than the first flux.

2. The method of claim 1, wherein (a) or (b) is performed by pervaporation.

3. The method of claim 1, wherein in (a), the first water selectivity is 3,500˜5,000, and the first flux is 50˜1,000 g/m²hr.

4. The method of claim 3, wherein in (b), the second water selectivity is 1,000˜3,500, and the second flux is 1,000˜2,000 g/m²hr.

5. The method of claim 1, wherein the first membrane is a first NaA zeolite membrane and the second membrane is a second NaA zeolite membrane.

6. The method of claim 5, wherein the first NaA zeolite membrane is prepared by hydrothermal synthesis for a period of time ranging from 1 hr to less than 12 hr, and the second NaA zeolite membrane is prepared by hydrothermal synthesis for 12˜24 hr.

7. The method of claim 5, wherein the first NaA zeolite membrane has the first water selectivity of 3,500˜5,000 and the first flux of 50˜1,000 g/m²hr.

8. The method of claim 5, wherein the second NaA zeolite membrane has the second water selectivity of 1,000˜3,500 and the second flux of 1,000˜2,000 g/m²hr.

9. The method of claim 5, wherein (a) or (b) is performed by pervaporation.
